(19) United States
(12) Patent Application Publication
(10) Pub. No.: US 2010/0143539 A1
(43) Pub. Date: Jun. 10, 2010

(54) METHOD OF TREATING COFFEE CHERRIES, GREEN COFFEE BEANS, ROASTED COFFEE BEANS, AND COFFEE DRINK

(75) Inventors: Yoshikiyo Minami, Kanagawa (JP); Yoshihiro Ido, Kanagawa (JP); Norihiko Yoshimoto, Kanagawa (JP); Nozomu Toyomura, Kanagawa (JP)

Correspondence Address: DRINKER BIDDLE & REATH (DC), 1500 K STREET, N.W., SUITE 1100, WASHINGTON, DC, 20005-1209, US

(73) Assignee: Suntory Holdings Limited, Osaka-shi (JP)

(21) Appl. No.: 12/515,462

(22) PCT Filed: Nov. 16, 2007
(86) PCT No.: PCT/JP2007/072701

§ 371 Date: Jan. 20, 2010

(30) Foreign Application Priority Data
Nov. 20, 2006 (JP) 2006-312922

(51) Int. Cl. A23F 5/00; A23F 5/02

(52) U.S. Cl. 426/45; 426/461; 426/629; 426/595; 426/594

(57) ABSTRACT

A method of treating coffee cherries, comprising a refining step for separating and refining green coffee beans from coffee cherries, wherein the coffee cherries are steam treated, after which the green coffee beans are separated and refined.

### TECHNICAL FIELD

The present invention relates to a method of treating coffee cherries comprising a refining step for separating and refining green coffee beans from coffee cherries.

### BACKGROUND ART

Coffee cherries are the fruit of a plant of the Rubiaceae family called “coffee tree” and are generally grown in tropical regions near the equator. Coffee cherry trees usually bloom, bear fruit, and can be harvested two to three years after seeding.

Current well-known methods of treating coffee cherries comprise a refining step, which may be washed or natural, for removing the outer skin and pulp portions from the coffee cherries and obtaining green coffee beans (see, e.g., Non-Patent Document 1).

Roasting the resulting green coffee beans yields roasted coffee beans. The flavor and aroma components that are the basis of the taste and aroma characteristic of coffee are generated in this roasting step for roasting green coffee beans.

The coffee flavor and aroma components can be extracted by pouring hot water or the like onto ground roasted coffee beans. The extract containing the coffee flavor and aroma components is a coffee drink.

The coffee cherries are harvested once ripe. If the region in which harvesting is taking place is tropical, spoilage may progress in a relatively short period of time due to the growth of bacteria and other undesirable microorganisms living on the coffee cherries. The refining step must therefore be implemented as quickly as possible after harvesting, but implementation in a short period of time may not be possible when the yield is extremely high, when manpower is inadequate, and under other such circumstances. Situations in which the quality of the coffee decreases and coffee cherries that were harvested must be discarded have therefore arisen when coffee cherries have spoiled.

The preferences of consumers for coffee drinks have diversified in recent years, and a variety of improvements in coffee flavor are needed. One such method of improvement that is well-known involves using microorganisms to subject the harvested coffee cherries to a fermentation treatment and adding new coffee flavors and aromas to the green coffee beans (see Patent Document 1).

Problems of contamination due to bacteria or the like living in the coffee cherries have arisen in this method when implementing the fermentation treatment using 1.5 microorganisms When contaminated by, e.g., acetic acid bacteria, the green coffee beans will absorb the acetic acid produced by the acetic acid bacteria, and the quality of the coffee drink obtained from the roasted coffee beans may decline precipitously.

When the coffee cherries are contaminated by, e.g., Aspergillus Flavus or other undesirable microorganisms capable of producing toxins, the green coffee beans may absorb the aflatoxin or other toxins produced by the undesirable microorganisms; and the coffee cherries may be unusable for eating or drinking.

Non-Patent Document 1. Michael Sivetz, M. S. and H. Elliott Foote, PhD “Coffee Processing Technology, Vol. 1” 1963, p. 48-49.

Patent Document 1. International Application Laid-Open No. 2005/029969 Pamphlet

### DISCLOSURE OF THE INVENTION

The present invention was devised in light of the aforementioned problems and provides a method of treating coffee cherries in which the quality of coffee cherries stored after harvesting can be improved, and biological contamination can be prevented when implementing a fermentation treatment on green coffee beans using microorganisms.

A first aspect of the present invention for achieving the aforementioned object is a method of treating coffee cherries, comprising:

a refining step for separating and refining green coffee beans from coffee cherries, wherein

the coffee cherries are steam treated, after which the green coffee beans are separated and refined.

According to this aspect, the coffee cherries are steam treated, whereby microorganisms attached to and living on the coffee cherries can be killed, and the initial number of contaminating microorganisms can be reduced. As a result, the growth of contaminating microorganisms can be slowed, the progression of spoilage of the coffee cherries can be limited, and the coffee cherries can be better preserved. Reductions in the quality of the coffee cherries or discarding of harvested coffee cherries can therefore be prevented beforehand. A larger amount of green coffee beans can therefore be obtained and production efficiency will increase (production costs will decrease) without any particular increases in the manpower or equipment required for the refining step. Less expensive green coffee beans can therefore be provided.

Two types of formats, i.e., washed and natural, are well-known in connection with the refining step for obtaining green coffee beans from coffee cherries. The present invention can be applied to both types of refining methods. In other words, once the harvested coffee cherries have been steam treated, the steam treated coffee cherries may be subjected to either a washed or a natural process.

In a second aspect of the present invention, the temperature of the steam is 70 to 150° C., and the treatment time is 5 s to 60 min.

According to the conditions of this aspect, the microorganisms living on the coffee cherries can be effectively sterilized in a short time at high temperatures, and reductions in quality due to biological contamination of the coffee cherries can be prevented beforehand. The sterilization period is short, and therefore the amount of water used is small, and the amount of wastewater can be reduced.

In a third aspect of the present invention, the temperature of the steam is 70 to 110° C., and the treatment time is 5 to 300 s.

Pressurized containers or other specialized equipment is not necessary when performing the steam treatment in this aspect, and therefore investments in equipment can be minimized. Sterilization is performed in a short time, and therefore losses in the quality of the flavor and aroma of the coffee cherries due to heat are small.

A fourth aspect of the present invention comprises a fermenting treatment that is performed on the steam treated coffee cherries, in which a microorganism and a nutritive substance contained in the coffee cherries are brought into contact, after which the green coffee beans are separated and refined.

The green coffee beans are present in the innermost part of the coffee cherry and have the property of absorbing water in preparation for sprouting. Certain types of microorganisms are well-known for degrading (fermenting) organic compounds (nutritive substances) and producing alcohols, organic acids, esters, and other compounds (referred to below as “fermented components”). These microorganisms are typified by yeast and the like. Therefore, when fermentation is performed using yeast or other microorganisms in the presence of nutritive substances and green coffee beans, the nutritive substances are degraded, and the fermented components that are produced will be absorbed by the green coffee beans along with water. As a result, when the green coffee beans that have absorbed the water and fermented components are roasted, roasted coffee beans can be obtained having new flavor and aroma components that originate from the fermented components in addition to the conventional coffee flavor and aroma components. New and favorable flavor and aroma can thus be imparted to the coffee drink resulting from performing extraction on these roasted coffee beans.

The primary nutritive substance in the present invention is coffee-cherry pulp (the portion containing sugars and other nutrients).

In the present invention, the aforedescribed fermenting treatment is implemented on steam-treated coffee cherries, and therefore the number of microorganisms living on the coffee cherries can be reduced, and the fermenting step can be performed in a state in which biological contamination has been prevented. The plant fibers of the coffee cherries swell and soften due to the steam treatment, whereby the microorganism can readily infiltrate into the coffee cherries. The sugars and the like contained within the coffee cherry pulp also readily dissolve, and fermentation by the Microorganism can be more readily promoted.

It a fifth aspect of the present invention, the microorganism is selected from among the group composed of yeast, lactic acid bacteria, and Deuteromycota.

The microorganisms that are given in this aspect are readily obtained and are easily handled due to the ability to apply general methods of culturing, storage, and the like.

In a sixth aspect of the present invention, the yeast is a wine-fermenting yeast.

According to this aspect, a characteristic brewed flavor and aroma can be imparted to the green coffee beans. By using these green coffee beans as a raw material, a coffee drink can be obtained having a fruity brewed aroma and a full-bodied taste in addition to the conventional coffee flavor and aroma generated in the roasting step.

In a seventh aspect of the present invention, the yeast belongs to the Saccharomyces family.

According to this aspect, when the fermentation treatment is performed using, e.g., Saccharomyces cerevisiae or Saccharomyces bayanus as the yeast belonging to the

Saccharomyces family, new flavor and aroma components (fermented components) can be imparted to the green coffee beans regardless of the microorganism used.

By using as a raw material the green coffee beans obtained using the aforementioned microorganisms in particular, a coffee drink can be obtained providing a full-bodied taste and having a fruity and rich estery aroma (in which alcohol smells are limited) balanced with the conventional coffee flavors generated in the roasting step.

In an eighth aspect of the present invention, the Deuteromycota belongs to the Geotrichum family.

According to this aspect, when the fermentation treatment is performed using, e.g., Geotrichum candidum, Geotrichum rectangulatum, or Geotrichum klebahnii as the Deuteromycota belonging to the Geotrichum family, new flavor and aroma components (fermented components) can be imparted to the green coffee beans regardless of the microorganism used.

By using as a raw material the green coffee beans obtained using the aforementioned microorganisms in particular, a coffee drink can be obtained providing a full-bodied taste and having a fruity and rich estery aroma (in which alcohol smells are limited) balanced with the conventional coffee flavors generated in the roasting step.

In a ninth aspect of the present invention, the Deuteromycota belonging to the Geotrichum family is Geotrichum sp. SAM2421 (international deposit number FERM BP-10300), a variant thereof, or a transformant thereof.

Geotrichum sp. SAM2421 (referred to below as “SAM2421”) was accepted into the International Patent Organism Depository of the National Institute of Advanced Industrial Science and Technology (#6 Chuo 1-1-1 Tsukuba-shi-higashi Ibaraki-ken Japan) on Mar. 22, 2005.

By using SAM2421, new flavor and aroma components (fermented components) are imparted to the green coffee beans. A coffee drink can thereby be obtained having a more fruity and rich estery aroma and providing a full-bodied taste

SAM2421, variants thereof, or transformants thereof may be used as appropriate in the present invention.

Variants include, e.g., strains having spontaneous mutations and strains in which radiation or mutagenic treatments are performed on the wild-type strain and mutation is artificially induced, while transformants include, e.g., wild-type SAM2421 or variants thereof into which foreign genes have been introduced. Strains having better fermentative ability or having other characteristics such as easy handling can be separated from these transformants and put to use.

In a tenth aspect of the present invention, the fermentation treatment is performed after the steam treated coffee cherries have been rapidly cooled to 40° C. or less within the space of one hour.

The microorganisms used in the fermentation treatment, e.g., wine-fermenting yeast, are not resistant to heat. A waiting period must therefore be implemented until the temperature of the steam treated coffee cherries decreases to a temperature appropriate for performing the fermentation treatment. When natural cooling is used, during the waiting period the quality of the coffee cherries may decline due to excessive heat, and contamination may occur due to the growth of small numbers of surviving undesirable microorganisms. However, rapid cooling is performed in this aspect, whereby deterioration of the quality of the coffee cherries can be prevented, the microorganisms used in the fermentation treatment can be quickly inoculated, and the growth of undesirable microorganisms can be minimized.

In an eleventh aspect of the present invention, a pH-regulating agent is added during the fermentation treatment or during the step before the fermentation treatment; and the pH is controlled between 2 and 5, whereby the fermentation treatment is performed.

In this aspect, the growth of undesirable microorganisms can be minimized in the fermentation treatment. Unusual tastes and odors are not present in the flavor and aroma of the green coffee beans that are ultimately separated and refined, and a favorable brewed aroma generated by fermentation is imparted even when the pH is limited between 2 and 5.

In a twelfth aspect of the present invention, the pH-regulating agent is at least one selected from among an organic acid, an organic acid salt, an inorganic acid, an inorganic acid salt, an amino acid, or an amino acid salt.

The pH-regulating agents given in this aspect are readily obtained and can effectively lower pH.

In a thirteenth aspect of the present invention, the pH-regulating agent is at least one selected from among the group composed of lactic acid, adipic acid, citric acid, malic acid, phosphoric acid, and acetic acid.

The, pH-regulating agents given in this aspect are inexpensive, readily obtained, and easily handled and stored. These agents have been approved for use in food products and can be safely consumed.

A fourteenth aspect of the present invention is green coffee beans obtained using the treatment method of the first aspect.

The green coffee beans of this aspect are inexpensive and contain fermented components that impart a new and favorable flavor and aroma to a coffee drink.

A fifteenth aspect of the present invention is roasted coffee beans resulting from roasting the green coffee beans of the fourteenth aspect.

The roasted coffee beans of this aspect are inexpensive and contain new flavor and aroma components originating from the fermented components produced by fermentation of the fermenting microorganism in addition to the conventional coffee flavor and aroma components generated in the roasting step.

A sixteenth aspect of the present invention is a coffee drink obtained using the roasted coffee beans of the fifteenth aspect as a raw material.

The coffee drink of this aspect is inexpensive and has a new and favorable flavor and aroma originating from the fermented components produced by fermentation of the fermenting microorganism in addition to the conventional coffee flavor and aroma.

### BEST MODE FOR CARRYING OUT THE INVENTION

Embodiments of the present invention will be described below.

### Embodiments

The method of treating coffee cherries of the present invention comprises a refining step for separating and refining green coffee beans from coffee cherries. To be more specific, the method of the present invention comprises (1) a washing and sorting step, (2) a steam treating step, (3) a rapid cooling step, (4) a fermenting step, (5) a drying step, and (6) a refining step. These steps are described hereinafter.

The method of treating coffee cherries of the present invention is implemented on harvested coffee cherries in order from (1) the washing and sorting step to (6) the refining step. Any selected steps other than (2) the steam treating step and (6) the refining step may be omitted as necessary, or the method may also be implemented using other steps in addition to steps (1) through (6) as appropriate.

(1) The washing and sorting step, (2) the steam treating step, (3) the rapid cooling step, (4) the fermenting step, (5) the drying step, and (6) the refining step will be described in order below.

(1) Washing and Sorting Step

The coffee cherries harvested from coffee trees are washed according to standard methods, and those cherries having the appropriate morphology (color, size, shape, and the like) are sorted from among these coffee cherries.

(Coffee Cherries)

“Coffee cherries” in the present invention refers to the fruit of the coffee tree. The general structure of a coffee cherry is composed of green coffee beans (seeds), pulp (the portions containing sugar and other nutrients), and an outer skin. To be more specific, the green coffee beans are present in the innermost part and are surrounded in order from the inside by the silver skin, the parchment, the pulp, and the outer skin.

Arabica, robusta, liberica, and the like may be used as appropriate as the variety of coffee. The area of production may be Brazil, Ethiopia, Vietnam, Guatemala, or another location as appropriate, but the area of production is not particularly limited.

2) Steam Treating Step

The washed and sorted coffee cherries are brought in contact with steam under the conditions described hereinafter, the microorganisms attached to and living on the coffee cherries are sterilized, and the initial number of contaminating microorganisms is reduced.

Examples of water that can be used for the steam treatment include soft water, hard water, oxygenated water, carbonated water, water containing vanadium, deep seawater, ionized water, alkaline water, and acidic water, but the water is not limited to these examples. Both saturated and super-saturated vapor may be used.

Higher treatment temperatures and longer treatments times are more effective as conditions of the steam treatment for minimizing contaminating microorganisms. However, the coffee cherries may be cooked or otherwise damaged under excessive treatment conditions (when the treatment temperature is too high or the treatment time is too long), and the favorable flavor and aroma may be lost. On the other hand, contamination by undesirable microorganisms may be induced under treatment conditions in which an adequate sterilization effect is not obtained; e.g., when the treatment temperature is too low or the treatment time is too short.

Therefore, the treatment temperature is preferably 70 to 150° C., and the treatment time is preferably 5 s to 60 min.

If the treatment temperature is 70 to 110° C., the steam treatment may be performed at atmospheric pressure without the necessity of pressurized containers and the like, and excessive equipment investments are therefore unnecessary.

If the treatment time is 5 to 300 s, Aspergillus Flavus and other undesirable microorganisms having the capacity to produce toxins can be thoroughly eradicated, and the fresh aroma and flavor of the cherries can be adequately maintained.

The method of the steam treatment can be thought of in the simplest terms as a method for dispersing steam through coffee cherries that are in a lined-up state.

An example of a preferable method for controlling the treatment temperature and the treatment time employs a metal vat whose temperature and pressure can be regulated, wherein steam-introducing portions are present in at least one or more locations. Alternatively, a method for controlling the treatment temperature and the treatment time involving the use of a conveyor that has an adjustable speed and that is provided with tunnel-shaped steam-introducing portions in at least one or more locations may also be employed, but these methods are not given by way of any particular limitation.

(3) Rapid Cooling Step

Examples of the method for rapid cooling include sprinkling cold water having a temperature of 0 to 40° C. onto the steam treated coffee cherries, immersing the coffee cherries in water having a temperature of 0 to 40° C., spreading the coffee cherries on the ground, and storing the coffee cherries in a refrigerator or other low-temperature container. A preferable method for controlling the treatment temperature and the treatment time involves the use of a conveyor that has an adjustable speed and that is provided with tunnel-shaped apertures for blowing cold (−30 to 40° C.) air in at least one or more locations, but these methods are not given by way of any particular limitation.

(4) Fermenting Step

Fermentation is performed for fermenting nutritive substances using the microorganisms described hereinafter, wherein the pulp of the rapidly cooled coffee cherries is used as the primary nutritive substance.

(4-1) Microorganism

The microorganisms that are applicable to the present invention are those microorganisms that can assimilate (ferment) the pulp and other portions of the coffee cherries. Examples include yeast, lactic acid bacteria, and Deuteromycota. These microorganisms can be ideally used due to being readily acquired and handled.

Brewing yeasts such as wine-fermenting yeasts and beer-fermenting yeasts that have a history of use in food products can be ideally used as yeasts from the perspective of food safety. The wine-fermenting yeast used may be, e.g., the Lalvin L2323 strain (Saccharomyces cerevisiae, referred to below as L2323, obtained from the Sceti Company), the Lalvin EC1118 strain (Saccharomyces bayanus, referred to below as EC1118, obtained from the Sceti Company), or the CK S102 strain (Saccharomyces cerevisiae, referred to below as S102, obtained from Bio Springer), which are commercial dried yeasts, but these examples are not given by way of any particular limitation.

L2323 is usually used for brewing red wine, EC1118 is usually used for brewing sparkling wine, and S102 is usually used for brewing rosé wines. A characteristic brewed flavor aroma can be added when such yeasts are used. Well-known bacteria used in the manufacture of fermented milk, lactic acid bacteria beverages, cheese-fermented milk, and other products may be applied as the lactic acid bacteria. Lactic acid bacteria of the Lactobacillus family are an ideal example.

Ideal examples of Deuteromycota include members of the Geotrichum family; e.g., Geotrichum candidum, Geotrichum rectangulatum, Geotrichum klebahnii, and, more preferably, Geotrichum sp. SAM2421 (international deposit number FERM BP-10300, referred to below as SAM2421), or variants and transformants thereof.

“Variants” in the present invention include strains having spontaneous mutations and strains obtained by treating wild-type strains with radiation, mutagens, or the like and artificially inducing mutations, in which the DNA-base sequence contains deletions, substitutions, or additions relative to the wild-type Geotrichum sp. SAM2421.

“Transformants” in the present invention refers to strains in which foreign genes from another type of organism are artificially introduced into the wild-type novel microorganism SAM2421 or variants thereof. The manufacturing process involves, e.g., integrating foreign genes into an appropriate expression vector and introducing the expression vector using an electroporation method, a calcium phosphate method, a liposome method, a DEAE dextran method, or another well-known method.

When using a dried microorganism, hydration can be performed according to the method appropriate for each case. For example, when using dried yeast, the yeast can be used after being soaked for 20 to 30 minutes in water heated to 37 to 41° C.

The amount of the microorganism to be used in the present invention is not particularly limited as long as the effect of added flavor and aroma is obtained, but the amount should be set appropriately while taking into consideration the culturing time and cost. Appropriate amounts per weight of coffee cherries are, e.g., 1.0×10⁵ cells/g to 1.0×10¹⁰ cells/g for yeast and lactic acid bacteria, and 1.0 mg/g to 10 mg/g for Deuteromycota.

(4-2) Nutritive Substances

The microorganism in the fermenting step of the present invention uses the pulp of the coffee cherries subjected to the steam treatment as the nutritive substance, but other nutritive substances may also be added and fermented as necessary.

Fruit pulp (e.g., coffee cherry pulp, grape pulp, cherry pulp, or peach pulp), fruit juice (e.g., grape, peach, or apple), sugars (e.g., monosaccharides, disaccharides, and polysaccharides from sugarcane, sweet potatoes, or other plants), grains (e.g., wort resulting from the glycosylation of malt), and culture media may be given as examples of possible additional nutritive substances, but the nutritive substances are not particularly limited as long as the substances can be assimilated by the microorganism. These nutritive substances can be used alone or in any desired combination.

The aforementioned additional nutritive substances are used after performing hot-water treatments, steam treatments or other sterilization treatments as necessary.

(4-3) Method for Bringing the Microorganism and the Nutritive Substances into Contact

Examples of methods for bringing the microorganism and the nutritive substances into contact in the fermenting step of the present invention are given below.

(a) Direct Method

The direct method involves bringing the microorganism into direct contact with the nutritive substances in the presence of green coffee beans. Direct contact and fermentation occur when, e.g., a suspension containing the microorganism is sprayed or sprinkled on coffee cherries in which at least a part of the coffee cherry pulp has been exposed (or on a mixture of green coffee beans and coffee cherry pulp obtained when separating out the green coffee beans in the refining step).

Particularly when fermentation is performed using coffee cherries in which part of the pulp is exposed, the assimilated sugars and the like are localized in the pulp at high concentrations, and therefore fermentation proceeds efficiently. The green coffee beans are present in close proximity, allowing the alcohols, esters, and other fermented components produced by fermentation to be rapidly transferred into the green coffee beans. Fermentation may also be performed with an appropriate amount of water when using dried coffee cherries or dried coffee cherry pulp.

(b) Indirect Method

The indirect method involves preparing a fermentation vat provided with a fermentation liquid. The green coffee beans, the nutritive substances, and the fermenting microorganism are added separately to the fermentation solution, and the fermenting microorganism is brought into contact with the nutritive substances that can dissolve into the fermentation liquid. For example, the fermenting microorganism and coffee cherries in which at least a part of the coffee cherry pulp has been exposed (or a mixture of green coffee beans and coffee cherry pulp obtained when separating out the green coffee beans in the refining step) are added to a fermentation liquid, and fermentation is performed.

(4-4) Method for Exposing Coffee Cherry Pulp

A method for exposing the coffee cherry pulp on at least a part of the surface of the coffee cherries may also be used in order to increase the rate of fermentation in the fermenting step of the present invention.

The method for exposing the coffee cherry pulp may involve damaging the coffee cherries using a sharp blade or the like before or after the steam treatment. Alternatively, the coffee cherries may be subjected to pressure using a threshing apparatus or the like so that openings are cut in the outer skin, but the damage must not extend to the green coffee beans within.

A peeling machine or the like may also be used so that only the outer skin of the coffee cherries is peeled and the pulp is exposed. The aforedescribed operations for exposing the pulp are not particularly necessary when the coffee cherries are accidentally; damaged and at least part of the pulp exposed during harvesting. The aforedescribed operations for exposing the pulp are also not particularly necessary when the coffee cherry pulp obtained when separating out the green coffee beans in the refining step is used, and fermentation is performed with the green coffee beans added separately

(4-5) Fermentation Conditions

The fermentation conditions of the microorganism are not particularly limited as long as fermentation occurs. Conditions appropriate for fermentation can be set appropriately as necessary. These conditions are, e.g., the type and amount (the initial number of cells) of microorganism used, the type and amount (concentration) of nutritive substances, the temperature, the humidity, the pH, the concentration of oxygen or carbon dioxide, and the fermentation time.

Besides the aforementioned nutritive substances, examples of other components that may be added as necessary include pH-regulating agents, other additives, and supplemental commercial nutrient media or the like for supplying sources of nitrogen and carbon.

In order to prevent contamination with undesirable microorganisms in the fermenting step, conditions such as temperature, pH, carbon dioxide concentration, and the like may be controlled individually or in any appropriate combination so as to limit the growth of undesirable microorganisms.

For example, fermentation may be performed in a low-temperature environment of 15 to 30° C., or fermentation may be performed under stringent acidic conditions by adding pH-regulating agents as necessary. Examples of the pH-regulating agent include lactic acid, adipic acid, citric acid, malic acid, acetic acid, other types of organic acids, various organic acid salts, phosphoric acid, other types of inorganic acids, various inorganic acid salts, various amino acids, and various amino acid salts.

The concentration of carbon dioxide may also be raised and fermentation implemented under more anaerobic conditions, or the concentration of oxygen may be raised and fermentation implemented under more aerobic conditions.

The fermenting step of the present invention may also be performed using constant-temperature vats, tanks, and containers that allow automatic and/or manual control of the aforementioned fermentation conditions. The conditions to be controlled are, e.g., the type and amount. (the initial number of cells) of microorganism used, the type, amount, and concentration of nutritive substances, the temperature, the humidity, the pH, the concentration of oxygen or carbon dioxide, and the fermentation time.

The time required for the fermenting step is not limited but should be appropriately selected according to the type and strength of the added flavor and aroma or according to the microorganism and the nutritive substances. The depletion of nutritive substances may also be used as an indication for ending the fermenting step.

The fermenting step may be ended by combining methods of heat sterilization, water washing, sun drying, separation of the nutritive substances and the green coffee beans, or roasting. When using, e.g., a drier, drying is performed at to −60° C. for approximately 1 to 3 days, whereby fermentation can be ended.

Microorganisms and fermentation conditions are all appropriately selected and combined as desired in the method of treating coffee cherries of the present invention, whereby a variety of flavors and aromas can be added to the green coffee beans. Two or more types of microorganism may also be selected and used simultaneously.

(4-6) Example Fermenting Step

An example of fermentation using coffee cherries will now be described.

The present invention may comprise, e.g., performing the fermenting step during the refining step of the green coffee beans.

A natural step involves, e.g., harvesting the coffee cherries, performing the steam treatment, then bringing the microorganism and the nutritive substances into contact using the aforedescribed (a) direct method, performing fermentation, and, finally, drying.

Meanwhile, a washed step involves, e.g., harvesting the coffee cherries, performing the steam treatment, then immersing the coffee cherries in a vat of water and removing impurities, using the aforedescribed (b) indirect method to add the microorganism and the coffee cherries to the vat of water (fermentation vat), and performing fermentation.

(5) Drying Step

After the fermenting step has ended, the microorganisms attached to the surface of the coffee cherries are washed away and separated from the coffee cherries using water, after which the coffee cherries are dried for approximately to 3 days using hot air having a temperature of approximately 40° C. Drying may also be performed with the fermenting microorganism still attached.

(6) Refining Step

Once the coffee cherries have been dried, the pulp and the like is removed according to a normal refining step, the cherries are stripped, and the green coffee beans are separated out.

Two types of formats, i.e., washed and natural, are well-known for the refining step for obtaining the green coffee beans from the coffee cherries.

The term “natural” refers to a method for obtaining green coffee beans in which the dried portions are stripped from the coffee cherries after harvesting, and the outer skin, pulp, parchment, silver skin, and the like are removed.

On the other hand, the term “washed” refers to a method for obtaining green coffee beans in which the coffee cherries are soaked in water after harvesting, impurities are removed, and the outer skin and pulp are removed using a pulp-removing machine, after which the coffee cherries are again immersed in water, and glutinous materials are dissolved and removed. The dried portions are then stripped after washing with water, and the parchment and silver skin are removed.

The operations of the natural process are simple, but this format is primarily applied in regions having a dry climate. On the other hand, washed processes are primarily applied in regions having frequent rainfall.

The green coffee beans in the present invention may be present as seeds within the coffee cherries or may be beans that have passed through the refining step and have been separated from the coffee cherries. One or two green coffee beans are extracted from one coffee cherry.

The green coffee beans that have been thus separated may be roasted using normal methods. Roasted coffee beans can be obtained having a variety of different degrees of roasting (from light to Italian roasting) by appropriately changing the conditions of the roasting treatment.

The resulting roasted coffee beans are ground, water is added, and filtration extraction is performed using a filtering material. The resulting liquid can be provided as regular coffee for consumption or can be used as an industrial raw material for instant coffee, coffee extracts, canned coffee, or the like.

### Examples

The present invention will be described in more detail below using examples, but the present invention is not limited to these examples.

### Example 1

### Investigations on the Effect of the Steam Treatment on Fermentation (the Effect of Minimizing Undesirable Microorganisms)

The effect of the steam treatment on fermentation was investigated using coffee cherries. A conveyor (a 2K conveyor-belt steamer made by Kawasaki Co.) having an adjustable speed and provided with tunnel-shaped steam-introducing portions was used to treat 1000 g of coffee cherries using a steam temperature of 100° C. and a treatment time of 30 s. 1000 g of the steam treated coffee cherries was put into a flask having a capacity of 3000 mL.

Next 4 g of sterilized water was added to 1 g of dried cells of the EC1118 strain, which is a wine-fermenting yeast, and the cells were dissolved. The resulting yeast solution was uniformly applied to 1000 g of the steam treated coffee cherries, which were left to stand and ferment for 48 hours at 23° C. (Sample 1). Coffee cherries that had not been steam treated were prepared as a control (Comparative Example 1).

The fermented coffee cherries were sampled over the course of time (at 1, 24, and 48 hours), and the number of undesirable microorganisms attached to the surface of the coffee cherries was measured.

In the measurement of the number of undesirable microorganisms, five coffee cherries were suspended in 15 mL of sterilized water. The supernatant was inoculated to a plate culture for microorganisms, after which culturing was performed for 48 hours in a constant-temperature incubator adjusted to 30° C. Once culturing was complete, colonies of cultured microorganisms other than the wine-fermenting yeast were counted as undesirable microorganisms, and the number of undesirable microorganisms per coffee cherry was obtained. The results are shown in Table 1. The results verified that the number of undesirable microorganisms was smaller in Sample 1 than in Comparative Example 1. These results show that, by steam treating the coffee cherries, the technique of the present invention is effective in limiting the growth of undesirable microorganisms.

TABLE 1

Number of undesirable microorganisms
per coffee cherry (×10⁴)

| Fermentation time | Sample 1 | Comparative Example 1 |
|---|---|---|
| 1 hours | 6 | 180 |
| 24 hours | 60 | 2700 |
| 48 hours | 2580 | 19500 |

The roasted coffee beans were evaluated next. The fermented coffee cherries of Sample 1 and Comparative Example 1 were dried at 40° C. using a drier. The pulp and skin were then removed using a pulping machine, and green coffee beans were obtained. These green coffee beans were roasted to an L value of 20.

A sensory evaluation was then performed on the roasted coffee beans by a panel of five specialists in coffee evaluation. 30 g of the roasted coffee beans of both Sample and Comparative Example 1 were put into specialized sampling glasses in their original, unground form, and the glasses were covered. The covers were removed at the time of the sensory evaluation, and estery aroma and unusual smells (spoilage) were evaluated. Evaluations were made in increments of 0.5 using five levels: weak (1), somewhat weak (2), moderate (3), somewhat strong (4), and strong (5). The results, which are expressed as the average values of the five evaluations, are shown in Table 2. According to the results, the roasted coffee beans of Sample 1 had a more favorable aroma than that of Comparative Example 1.

TABLE 2

| | | Sample 1 | Comparative Example 1 |
|---|---|---|---|
| Aroma | Estery aroma | 4.5 | 3.8 |
| | Unusual smells | 0.5 | 4.3 |
| | (spoilage) | | |

Coffee extracts were prepared using the roasted coffee beans of Sample 1 and Comparative Example 1. The roasted coffee beans were finely ground. 100 g of hot water was added to and stirred with 12 g of ground beans. The coffee that floated to the top was removed, and a sensory evaluation was performed on the supernatant fluid in accordance with a standard cup-test method. The sensory evaluation was performed by a panel of five coffee specialists. The categories of evaluation were: aroma (estery aroma and unusual smells (spoilage)) and taste (body and acidity). Evaluations were made in increments of 0.5 using five levels: weak (1), somewhat weak (2), moderate (3), somewhat strong (4), and strong (5). The results, which are expressed as the average values of the five evaluations, are shown in Table 3. According to the results, the coffee extract of Sample 1 had a more favorable aroma and flavor than that of Comparative Example 1.

TABLE 3

| | | Sample 1 | Comparative Example 1 |
|---|---|---|---|
| Aroma | Estery aroma | 4.2 | 3.5 |
| | Unusual smells | 0.5 | 4.2 |
| | (spoilage) | | |
| Flavor | Body | 3.8 | 3.8 |
| | Acidity | 2.1 | 4.5 |

### Example 2

### Investigations on the Temperature and Time Conditions of the Steam Treatment

A pressurized container (HTS-70/160, made by Hisaka Works, LTD.) having adjustable temperature and pressure and provided with steam-introducing portions was used for steam treating coffee cherries.

The steam treatments were performed on coffee cherries under the following conditions:

70° C. steam temperature and 60 s treatment time (Sample 2-1);

100° C. steam temperature and 5 s treatment time (Sample 2-2);

100° C. steam temperature and 30 s treatment time (Sample 2-3);

100° C. steam temperature and 300 s treatment time (Sample 2-4);

100° C. steam temperature and 60 min treatment time (Sample 2-5);

110° C. steam temperature and 30 s treatment time (Sample 2-6); and

150° C. steam temperature and 10 s treatment time (Sample 2-7).

After the steam treatment, fermentation was performed in accordance with Example 1, and the numbers of undesirable microorganisms during fermentation were measured. Coffee cherries that had not been steam treated were tested in the same manner as a control (Comparative Example 2). The results are shown in Table 4. The results verified that the number of undesirable microorganisms was smaller when the steam treatment was performed than in Comparative Example 2.

TABLE 4

| | Number of undesirable microorganisms per coffee cherry (×10⁴) | | | | | | | |
|---|---|---|---|---|---|---|---|---|
| Ferm. | Sample | Sample | Sample | Sample | Sample | Sample | Sample | Comp. |
| time | 2-1 | 2-2 | 2-3 | 2-4 | 2-5 | 2-6 | 2-7 | Ex. 2 |
| 0 hours | 0.14 | 0.3 | 0.54 | 0.03 | 0 | 0.06 | 0.03 | 1.29 |
| 24 hours | 210 | 120 | <1 | <1 | <1 | <1 | 120 | 1380 |
| 48 hours | 6510 | 1080 | 60 | <1 | <1 | <1 | <1 | 8370 |

### Example 3

### Investigations on Rapid Cooling After the Steam Treatment

The effect on fermentation of rapid cooling after the steam treatment was investigated using coffee cherries. After performing the steam treatment (using a 100° C. steam temperature and a 30 s treatment time) on 1000 g of coffee cherries in accordance with Example 1, coffee cherries that had been rapidly cooled to 40° C. or less within 5 minutes using a cooling apparatus (Sample 3) and coffee cherries that were left to stand for 12 hours until the temperature reached 40° C. or less (Comparative Example 3) were fermented in accordance with Example 1, and the numbers of undesirable microorganisms during fermentation were measured. The results are shown in Table 5. According to the results, fermentation was able to be completed while maintaining a small number of undesirable microorganisms in Sample 3 more so than in Comparative Example 3.

Rapid cooling to 40° C. or less was also performed within 1 hour, whereby fermentation was able to be completed while maintaining a small number of undesirable microorganisms, as in Sample 3, though these results are not shown.

TABLE 5

Number of undesirable microorganisms
per coffee cherry (×10⁴)

| Fermentation time | Sample 3 | Comparative Example 3 |
|---|---|---|
| 1 hours | 6 | 7422 |
| 24 hours | 60 | 45960 |
| 48 hours | 2580 | 25140 |

### Example 4

### Investigations on the Type of Yeast

The effects of different types of yeast on fermentation were investigated using coffee cherries. After performing the steam treatment (using a 100° C. steam temperature and a treatment time) on 1000 g of coffee cherries in accordance with Example 1, coffee cherries that had been rapidly cooled to 40° C. or less were fermented in accordance with Example 1 using strain EC1118 (Sample 4-1) or strain CK S102 (Sample 4-2). According to the results, fermentation was able to be properly completed without substantial growth of undesirable microorganisms in both Samples 4-1 and 4-2.

The fermented coffee cherries were then dried at 40° C., after which the cherries were stripped, and green coffee beans were recovered. The green coffee beans were roasted to an L value of 20, and the aroma was evaluated by panelists in accordance with Example 1. The results verified that both Samples 4-1 and 4-2 were imparted with a favorable estery aroma due to the fermentation.

TABLE 6

| | | Sample 4-1 | Sample 4-2 |
|---|---|---|---|
| Aroma | Estery aroma | 4.5 | 4.3 |
| | Unusual smells | 0.5 | 0.7 |
| | (spoilage) | | |

### Example 5

### Investigations on the pH-Regulating Agent

The effect on fermentation of the pH-regulating agent (the effect of minimizing undesirable microorganisms) was investigated in fermentation treatments on coffee cherries using microorganisms. After performing the steam treatment (using a 100° C. steam temperature and a 30 s treatment time) on 500 g of coffee cherries in accordance with Example 1, the coffee cherries were rapidly cooled to 40° C. or less within 5 minutes using a cooling apparatus. A mixture was then prepared in which 300 g of a 20,000 ppm solution of adipic acid (pH 2.60) was added to the coffee cherries (Sample 5-1).

Mixtures in which 300 g of a 1300 ppm solution of adipic acid (pH 3.30) (Sample 5-2), 300 g of a 10 ppm solution of adipic acid (pH 4.64) (Sample 5-3), 300 g of a 14,000 ppm solution of lactic acid (pH 2.68) (Sample 5-4), 300 g of a 390 ppm solution of phosphoric acid (pH 2.66) (Sample 5-5), or 300 g of sterilized water (pH 6.00) (Comparative Example 5) were added to 500 g of steam treated coffee cherries were also simultaneously prepared.

Next, 2.5 g of a yeast solution (strain EC1118) prepared in accordance with Example 1 was added to each mixture, thoroughly stirred, and left to stand for 48 hours.

In the measurement of the number of undesirable microorganisms, the supernatant was sampled over the course of the fermentation (at 1, 24, and 48 hours). The supernatant was inoculated to a plate culture for microorganisms, after which culturing was performed for 48 hours in a constant-temperature incubator adjusted to 30° C. Once culturing was complete, colonies of cultured microorganisms other than the wine-fermenting yeast were counted as undesirable microorganisms, and the number of undesirable microorganisms per coffee cherry was obtained. The results verified that the number of undesirable microorganisms was kept low until the end of fermentation in Samples 5-1, 5-2, 5-3, 5-4, and 5-5, more so than in Comparative Example 5.

The growth of undesirable microorganisms can thus be minimized in the fermentation treatment when the pH is controlled to approximately 2 to 5. Unusual tastes and odors are not present in the flavor and aroma of the green coffee beans that are ultimately separated and refined, and a favorable brewed aroma generated by fermentation is imparted.

TABLE 7

| | Number of undesirable microorganisms per coffee cherry (×10⁴) | | | | | |
|---|---|---|---|---|---|---|
| Ferm. | Sample | Sample | Sample | Sample | Sample | Comp. |
| time | 5-1 | 5-2 | 5-3 | 5-4 | 5-5 | Example 5 |
| 0 hours | 0.039 | 0.039 | 0.039 | 0.039 | 0.039 | 0.039 |
| 24 hours | <1 | <1 | <1 | <1 | <1 | 200000 |
| 48 hours | <10 | <10 | 20000 | <10 | 900 | 60000 |

### INDUSTRIAL APPLICABILITY

The present invention can be used in a method of treating coffee cherries comprising a refining step for separating and refining green coffee beans from coffee cherries.

1. A method of treating coffee cherries, comprising:
a refining step for separating and refining green coffee beans from coffee cherries, wherein
the coffee cherries are steam treated, after which the green coffee beans are separated and refined.

2. The method of treating coffee cherries according to claim 1, wherein the temperature of the steam is 70 to 150° C., and the treatment time is 5 s to 60 min.

3. The method of treating coffee cherries according to claim 2, wherein the temperature of the steam is 70 to 110° C., and the treatment time is 5 to 300 s.

4. The method of treating coffee cherries according to claim 1, comprising a fermenting treatment that is performed on the steam treated coffee cherries, in which a microorganism and a nutritive substance contained in the coffee cherries are brought into contact, after which the green coffee beans are separated and refined.

5. The method of treating coffee cherries according to claim 4, wherein the microorganism is selected from among the group composed of yeast, lactic acid bacteria, and Deuteromycota.

6. The method of treating coffee cherries according to claim 5, wherein the yeast is a wine-fermenting yeast.

7. The method of treating coffee cherries according to claim 5, wherein the yeast belongs to the Saccharomyces family.

8. The method of treating coffee cherries according to claim 5, wherein the Deuteromycota belongs to the Geotrichum family.

9. The method of treating coffee cherries according to claim 8, wherein the Deuteromycota belonging to the Geotrichum family is Geotrichum sp. SAM2421 (international deposit number FERM BP-10300), a variant thereof, or a transformant thereof.

10. The method of treating coffee cherries according to claim 4, wherein the fermentation treatment is performed after the steam treated coffee cherries have been rapidly cooled to 40° C. or less within the space of one hour.

11. The method of treating coffee cherries according to claim 4, wherein
a pH-regulating agent is added during the fermentation treatment or during the step before the fermentation treatment; and
the pH is controlled between 2 and 5, whereby the fermentation treatment is performed.

12. The method of treating coffee cherries according to claim 11, wherein the pH-regulating agent is at least one selected from among an organic acid, an organic acid salt, an inorganic acid, an inorganic acid salt, an amino acid, or an amino acid salt.

13. The method of treating coffee cherries according to claim 12, wherein the pH-regulating agent is at least one selected from among the group composed of lactic acid, adipic acid, citric acid, malic acid, phosphoric acid, and acetic acid.

14. The green coffee beans obtained by using the treatment method according to claim 1.

15. Roasted coffee beans resulting from roasting the green coffee beans according to claim 14.

16. A coffee drink obtained using the roasted coffee beans according to claim 15 as a raw material.
